(19) United States
(12) Patent Application Publication
(10) Pub. No.: US 2006/0145000 A1
(43) Pub. Date: Jul. 6, 2006

(54) Multi-fuselage aircraft

(76) Inventor: Robert Hensley, Clearwater, FL (US)

Correspondence Address: Michael C. Gilchrist;Dorsey & Whitney LLP, Suite 3900, 801 Grand, Des Moines, IA, 50309-2790, US

(21) Appl. No.: 11/260,821

(22) Filed: Oct. 27, 2005

Related U.S. Application Data
(60) Provisional application No. 60/700,186, filed on Jul. 18, 2005.
(60) Provisional application No. 60/522,676, filed on Oct. 27, 2004.

(51) Int. Cl. B64C 35/00

(52) U.S. Cl. 244/106

(57) ABSTRACT

An aircraft is suitable for ground and water take-offs and landings. The aircraft includes at least two fuselages spaced apart from each other. Each fuselage acts as a pontoon to permit landing and take-off from water.

This application claims priority from U.S. Provisional Application No. 60/700,186 filed Jul. 18, 2005 and from U.S. Provisional Application No. 60/522,676 filed Oct. 27, 2004; the contents both of which are herby incorporated in their entirety by reference.

### BACKGROUND

This invention relates generally to aircraft and more specifically to amphibious aircraft having more than one fuselage that are suitable for landing on water as well as ground.

Amphibious aircraft are know in the art. Often times these amphibious aircraft have taken the form of conventional aircraft provided with floats. Alternatively, aircraft that have buoyant fuselages have also been used. However, these past designs have tended to be inelegant. They have suffered from a lack of aesthetic appeal as well as rather poor performance as compared to aircraft that are not equipped to take-off from and land on water. Furthermore, the performance of these aircraft as watercraft, once they are on the water, has been largely been ignored and could be greatly improved.

Accordingly, there is a need for an amphibious aircraft within improved in-flight and on-water characteristics.

### SUMMARY OF THE INVENTION

According to one embodiment the present invention is an aircraft having a first fuselage including a first compartment and a second fuselage including a second compartment. An airfoil is provided in operable connection to the first and second fuselages. An engine is provided in operable connection to the airfoil for providing propulsion. The first and second fuselages include bottom hull portions that act as pontoons to permit the aircraft to land and take-off from water. The fuselages and airfoil may comprise carbon graphite composite material. The front nose portion of at least one of the fuselages may be hinged at a top portion to the remainder of the fuselage so that the nose portion may be pivoted upwardly to provide a large opening into the fuselage for easy loading and unloading of cargo. The airfoil may comprise an upper wing located generally above the fuselages and a lower wing located generally between the fuselages.

### SUMMARY OF THE DRAWINGS

FIG. 1 is a top plan view of a multi fuselage amphibious aircraft according to one embodiment of the present invention;

FIG. 2 is a front elevation view of the aircraft of FIG. 1;

FIG. 3 is a side elevation view of the aircraft of FIG. 1;

FIG. 4 is a side elevation view of the aircraft of FIG. 1 with a nose portion adjusted to an open loading position;

FIG. 5a is a side elevation view of a passenger aircraft designed to carry about thirteen passengers and one pilot, according to one embodiment of the present invention;

FIG. 5b is a partial detailed front view of a fuselage according to the embodiment of FIG. 5a;

FIG. 6 is a side elevation view of a vertical stabilizer according to the embodiment of FIG. 5a;

FIG. 7 is a top plan view of a horizontal stabilizer according to the embodiment of FIG. 5a;

FIG. 8a is a top plan view of an upper wing according to the embodiment of FIG. 5a;

FIG. 8b is a cross sectional view of the upper wing of FIG. 8a taken along line 8b-8b of FIG. 8a;

FIG. 8c is a cross sectional view of the upper wing of FIG. 8a taken along line 8b-8b of FIG. 8a;

FIG. 9a is an upper plan view of a lower wing according to the embodiment of FIG. 5a;

FIG. 9b is a cross sectional view of the lower wing of FIG. 9a taken along line 9b-9b of FIG. 9a; and

FIG. 10 is an example of a worksheet used to calculate the location of the center of gravity of the aircraft of FIG. 5a.

### DETAILED DESCRIPTION OF PREFERRED EMBODIMENTS

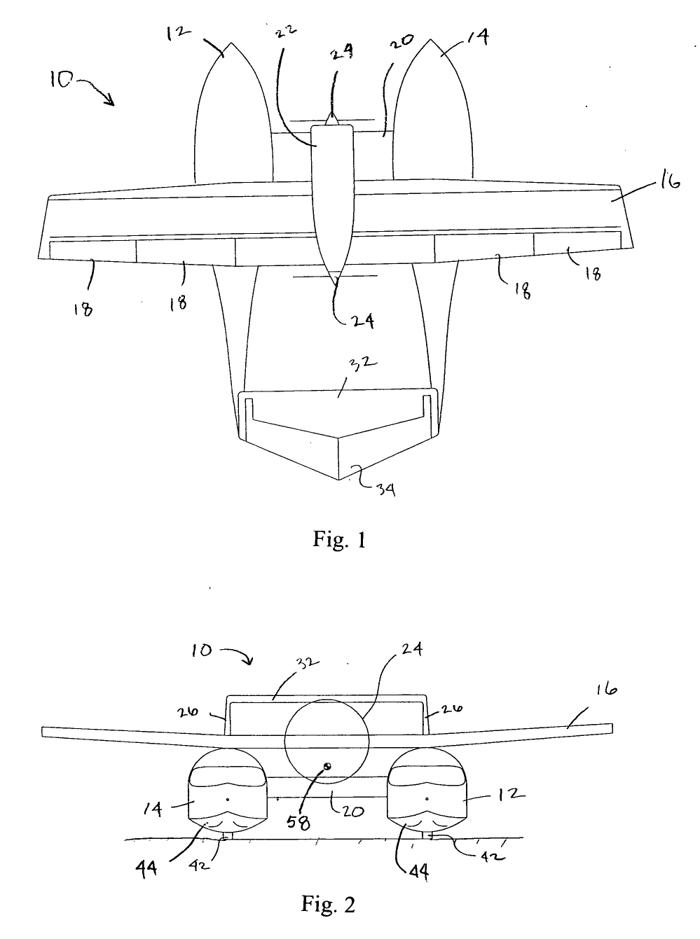

Shown generally in FIGS. 1-3 is an amphibious aircraft 10 according to one embodiment of the present invention. The aircraft 10 includes a first fuselage 12 and a second fuselage 14. The fuselages 12 and 14 are preferably sized and shaped similarly to each other, and are most preferably mirror images of each other. The fuselages 12 and 14 should be watertight so that they can act as pontoons for the aircraft 10. As best seen in FIG. 1 each of the fuselages 12 and 14 gradually taper to the rear. This gradual tapering helps maintain laminar airflow across the fuselages 12 and 14, in order to reduce the overall drag on the aircraft 10 as it is in flight.

A large upper wing 16 unfastens to the top of the fuselages 12 and 14. The upper wing 16 acts as a airfoil to provide lift for the aircraft 10. The upper wing 16 will include adjustable control surfaces 18 to help guide the flight of the aircraft 10. A lower wing 20 is mounted between the two fuselages 12 and 14 to provide additional lift. The lower wing 20 may also be provided with control surfaces (not shown). The wings 16 and 20 also provide structural support to connect the fuselages together.

A nacelle 22, or similar housing, is secured to the top of the upper wing 16 and encloses a propulsion device 24. The propulsion device 24 may include any suitable motor. For example, a pair in-line turbo diesel engines, a single turbo prop, or one or more jet engines. The location of the propulsion device 24 on the top of the upper wing 16 and centered between the fuselages 12 and 14 is advantageous for several reasons. First, by locating the propulsion device 24 on top of the upper wing 16, the propulsion device 24 is kept at a maximum distance away from the water during take-off and landing. This is desired because it helps prevent damage or fouling of the propulsion device 24 from contact with the body of water, or spray from the body of water during take-off and landing. Additionally, by locating the propulsion device 24 between the fuselages 12 and 14, and by providing access to the fuselages on the outboard sides of the fuselages, there will be little reason for passengers or pilots to venture between the fuselages 12 and 14 where they might be injured by the propulsion device 24. Locating the propulsion device 24 at the center line between the fuselages 12 and 14 also eliminates asymmetrical thrust that can result from laterally offset propulsion devices, especially during take-off.

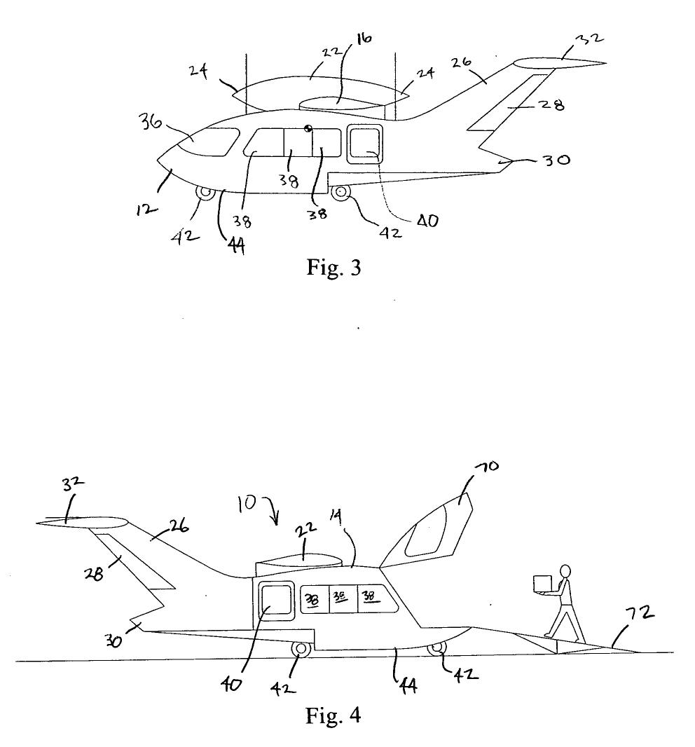

At best seen in FIG. 3 the rear, or aft, portion of each fuselage 12 and 14 includes an upwardly extending vertical stabilizer 26 that includes a rudder 28. The lower rear portion of each of the fuselages 12 and 14 includes a rearwardly extending tailfin 30. While not shown, the tailfin 30 may include a rudder to aid in steering the aircraft 10 when it is in water. A horizontal stabilizer 32 including an adjustable elevator flap 34 spans between the top edges of the vertical stabilizers 36.

The fuselages 12 and 14 each enclose a compartment that may be used for carrying passengers or cargo. At least one, and optionally both, of the fuselages 12 and 14 includes a compartment with controls for a pilot to operate the aircraft 10. The compartments may be provided with seats and other standard fixtures for passengers. Alternatively, the compartments may be equipped with shelving and the like to provide for cargo. The two compartments need not be equipped similarly. For example, one compartment could be provided with seating for passengers, while the other compartment is outfitted to carry luggage or other cargo. One of the compartments could be equipped as a living quarters including a bed, toilet facilities and cooking equipment. An aircraft 10 equipped with one of its compartments outfitted as a living quarters would be well-suited for use as a flying yacht that would permit a user to fly to a desired location and dock the aircraft 10. While it is not necessary to similarly equip the two compartments, it may be desirable to try and keep their overall weights similar for handling purposes.

As best seen in FIG. 3, each fuselage 12 and 14 includes a windshield 36 at the forward portion of the fuselages 12 and 14 to permit the pilot, or other passenger, to observe conditions outside the aircraft 10. Additional windows 38 may also be provided along the sides of the fuselages 12 and 14 to permit passengers to have a view outside the aircraft 10. If the aircraft 10 is expected to be used solely as a cargo carrier, windows 38 may be unnecessary. A door 40 is also provided to permit the pilot and passengers entry and exit from the aircraft 10. The door 40 may be of the type that pivots outwardly and downwardly to form stairs in order to aid passengers and pilots in entering the aircraft 10. Preferably the compartment within each fuselage 12 and 14 will be pressurized and will be provided with heat to provide a safe and comfortable environment for pilots, passengers, and cargo.

The lower portion of each fuselage 12 and 14 is provided with landing gear 42. If the aircraft 10 is intended for use solely as a seaplane it would be permissible to eliminate the landing gear 42. Preferably, the landing gear 42 will be retractable so that when the aircraft 10 is in flight, and especially when it is taking-off or landing in water, the landing gear 42 are retracted into the respective fuselage 12 and 14 so that the exterior surface of the aircraft 10 is relatively smooth and uninterrupted by protrusions.

Having broadly described the features of the aircraft 10, it is appropriate to exam the design considerations and details of the fuselages 12 and 14, the wings 16 and 20. The bottom portion of each fuselage 12 and 14 acts as a hull 44 when the aircraft 10 is in water. The design of the hull portion 44 of the fuselages 12 and 14 is therefore critical for the determining how the aircraft 10 will handle during take-off, landing, and when at sea. Several standard measurements and ratios are useful in discussing the configuration of the hull 44. The unique combination of these factors in the present invention gives the aircraft 10 many of its desired features.

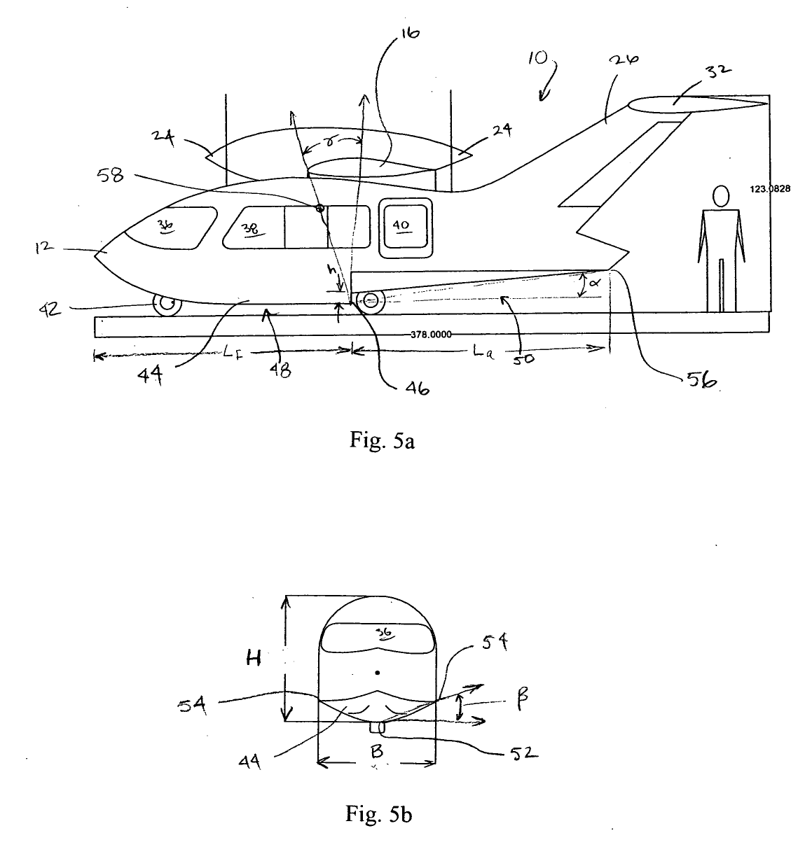

The hull portions 44 of the fuselages 12 and 14 are the bottom portions of the fuselages 12 and 14 that can be expected to come in contact with water during take-offs, landings, or when idle in the water. The hull portion 44 includes a step 46 where the lateral configuration of the hull portion 44 abruptly changes. The step 46 is located about midway between the front and rear of the hull portion 44 and has a depth h. The portion of the hull 44 that is forward of the step 46 is considered the forebody 48, while the portion of the hull 44 aft from the step 46 is considered the afterbody 50. The bottom most portion of the hull 44 is known as the keel 52. The edges along which the bottom of the hull 44 meets the vertical sides of the fuselage 12 and 14 is known as the chines 54. The width of the hull 44 is known as the beam, and is represented as measurement B in FIG. 5b. The rear edge of the afterbody 50 is known as the sternpost 56. A sternpost angle α is defined as the angle between the hull 44 at the step 46 and a line from the step 46 to the sternpost 56. A deadrise angle β, shown in FIG. 5b, is measured between the keel 52 and the chine 54. The step 46 is offset rearwardly from center of gravity 58 of the aircraft 10 at an angle γ. Preferably, angle γ is between 10 and 20 degrees.

As best seen in FIGS. 5a and 5b, one embodiment of the present invention utilizes a hull 44 wherein the length L_{f} of the forebody 48 is approximately equal to the length Lₐ of the afterbody 50. The ratio of L_{f} and Lₐ to the beam length b is approximately 2.2:1. The sternpost angle α of the embodiment shown is approximately 7 degrees. The ratio of the step depth h to the beam b is about 1:11. The deadrise angle β for the afterbody 50 is about 25 degrees.

Important factors considered in determining the hull design include the ratio of the forebody length to the beam versus the hull spray characteristics; the ratio of the afterbody length to the beam versus the step depth; the sternpost angle versus the step depth; the afterbody deadrise angle versus length, step depth, and sternpost angle; the wing loading versus gross weight; and power loading versus gross weight. Existing tables and charts that compile data from existing aircraft may be used to compare the noted design factors with empirical data to give an estimate of whether the proposed configuration will be stable during take-off, flight, and landing. The configuration shown and described in FIGS. 5a and 5b produces satisfactory results with respect to take-off and landing based on these factors.

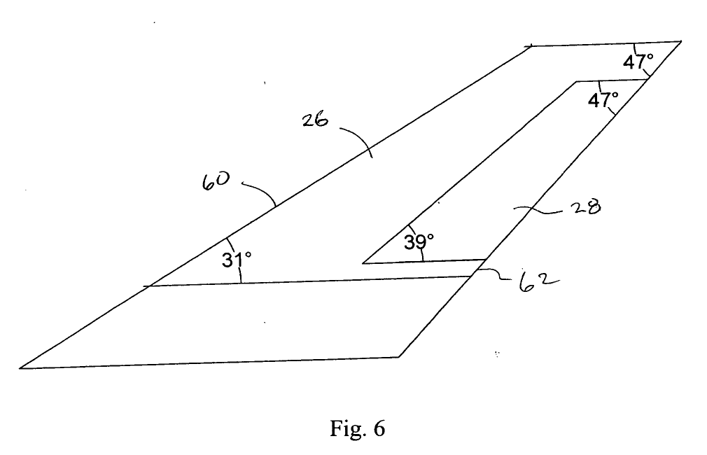

As best seen in FIG. 3 the rear portion of the fuselages 12 and 14 take the form of vertical stabilizers 26. These vertical stabilizers 26 angle upwardly and rearwardly away from the fuselages 12 and 14. FIG. 6 shows details of one embodiment of a vertical stabilizer 26 according to the present invention. The vertical stabilizer 26 of FIG. 6 has a leading edge 60 that has a flatter angle than a trailing edge 62. In the embodiment shown the leading edge 60 has an angle of approximately 31 degrees with respect to horizontal and the trailing edge 62 forms an angle of about 47 degrees with respect to horizontal. The rear rudder 28 shares trailing edge 62 with the vertical stabilizer 26, and has a leading edge 64 formed at an angle of about 39 degrees with respect to horizontal. Other configurations with different angles and relative sizes may also be acceptable for the vertical stabilizer 26.

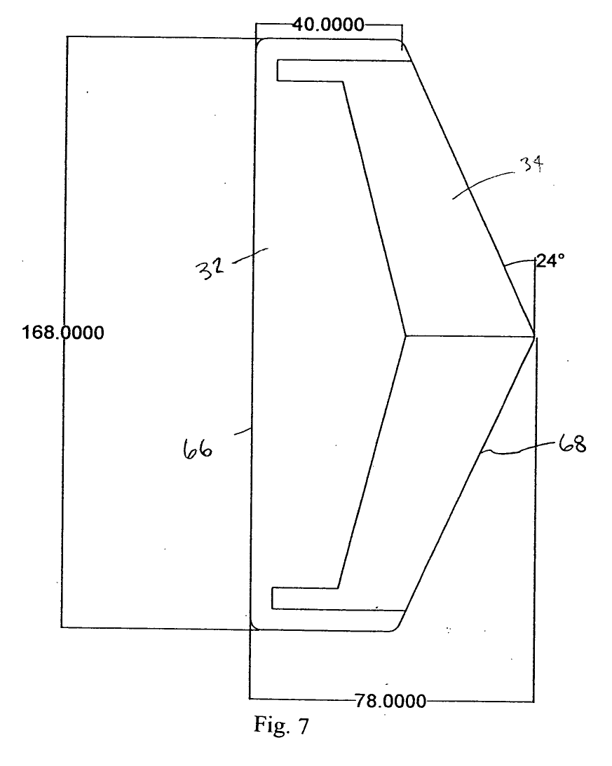

A preferred embodiment of a horizontal stabilizer 32 and an elevator 34 is shown is shown in FIG. 7. According to the embodiment of FIG. 7 the overall shape of the stabilizer 32 and elevator 34 is that of a pentagon. A leading edge 66 of the horizontal stabilizer 32 is generally perpendicular to a direction of travel for the aircraft 10. The trailing edge 68 of the elevator 34 has two legs that angle rearwardly at an angle of about 24 degrees with respect to the leading edge 66. The embodiment shown in FIG. 7 shows dimensions for one embodiment of the aircraft 10 that is suited for carrying approximately 14 total passengers including a pilot. The dimensions shown are in inches; however, it should be appreciated that the dimensions are not necessarily critical, and the horizontal stabilizer 32 and elevator 34 could be scaled to fit any desired size aircraft 10.

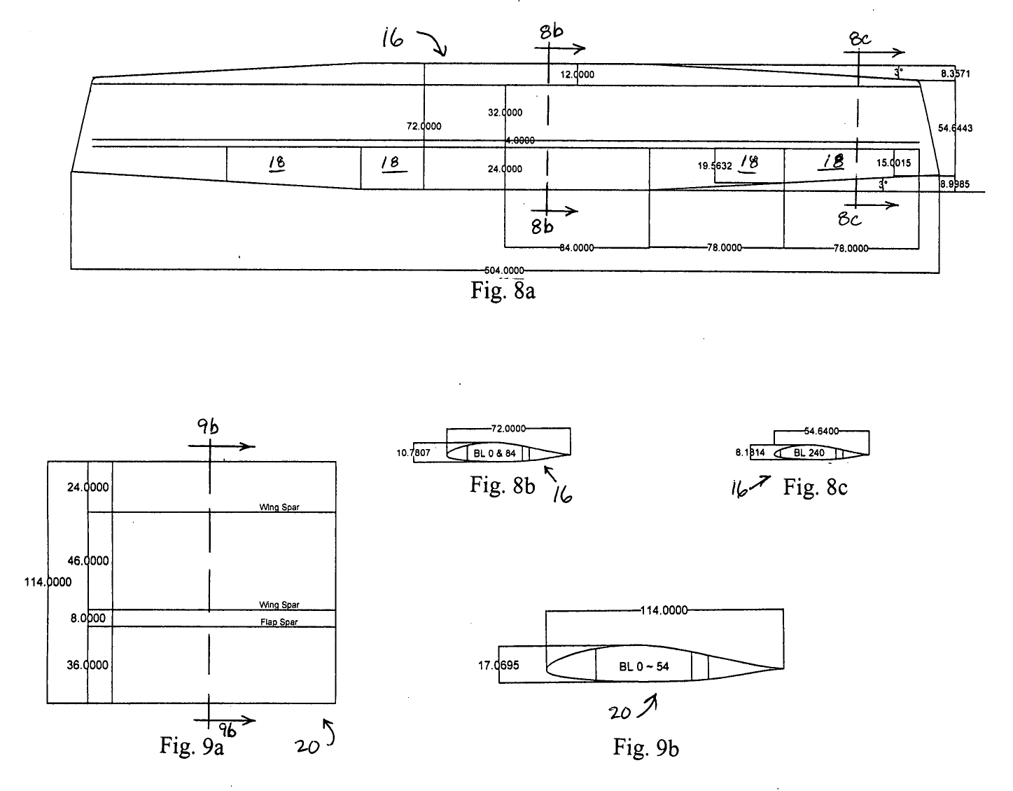

The choice of the airfoils for the upper wing 16 and lower wing 20 depends on several variables. For the purpose of an amphibious aircraft 10, the important factors are a low stall velocity, low cruise drag, and low moment coefficient. Preferably the airfoil will be a laminar airfoil in order to reduce drag. FIGS. 8 & 9 show upper wing 16 and lower wing 20 according to one embodiment of the present invention. The dimensions shown in these figures are for an embodiment of an aircraft 10 sized to carry up to 14 passengers. These wings may be scaled to suit other applications. The cross-section of the wings, shown in FIGS. 8b & c and 9b correspond to airfoil number 747A315 manufactured by Boeing. This particular airfoil was selected because of its low overall drag, relatively low moment coefficient and desirable coefficient of lift. In the embodiment of FIGS. 8a, b & c, the upper wing 16 tapers slightly (at an angle of about 3 degrees) at its distal end. The lower wing 20 has a constant width across its entire extent. Both the upper wing 16 and lower wing 20 include control surfaces 18 in order to selectively change the characteristics of the wings 16 and 20.

FIG. 4 shows an aircraft 10 according to one embodiment of the present invention. According to the embodiment of FIG. 4 a nose portion 70 is pivotally attached to the fuselage 14 so that the nose portion 70 may be pivoted upwardly to the orientation shown in FIG. 4. In open orientation of FIG. 4 the nose portion 70 has been rotated upwardly to expose a large opening into the compartment within fuselage 14. This permits a user to easily carry or roll cargo into the compartment within the fuselage 14. Airtight seals and locks (not shown) should be provided with the nose portion 70 in order to ensure when it was adjusted to the closed position the fuselage 14 is airtight and watertight. A ramp 72 may be provided separately, or as a fold out option in order to further aid in loading the aircraft 10. Preferably the control equipment for the pilot will be located in the first fuselage 12, when the second fuselage 14 is provided with the pivoting nose portion 70. In other words, the pivoting nose portion 70 is preferably provided on the fuselage that does not include control equipment for the pilot.

With respect to the aircraft shown in FIGS. 1-3 it should be appreciated that the various components could be sized large or small as long as they remain in scale with each other, depending upon the needs of the user. Therefore, the aircraft 10 could be made relatively small to handle only a few passengers or could be scaled large in order to handle great quantities of cargo.

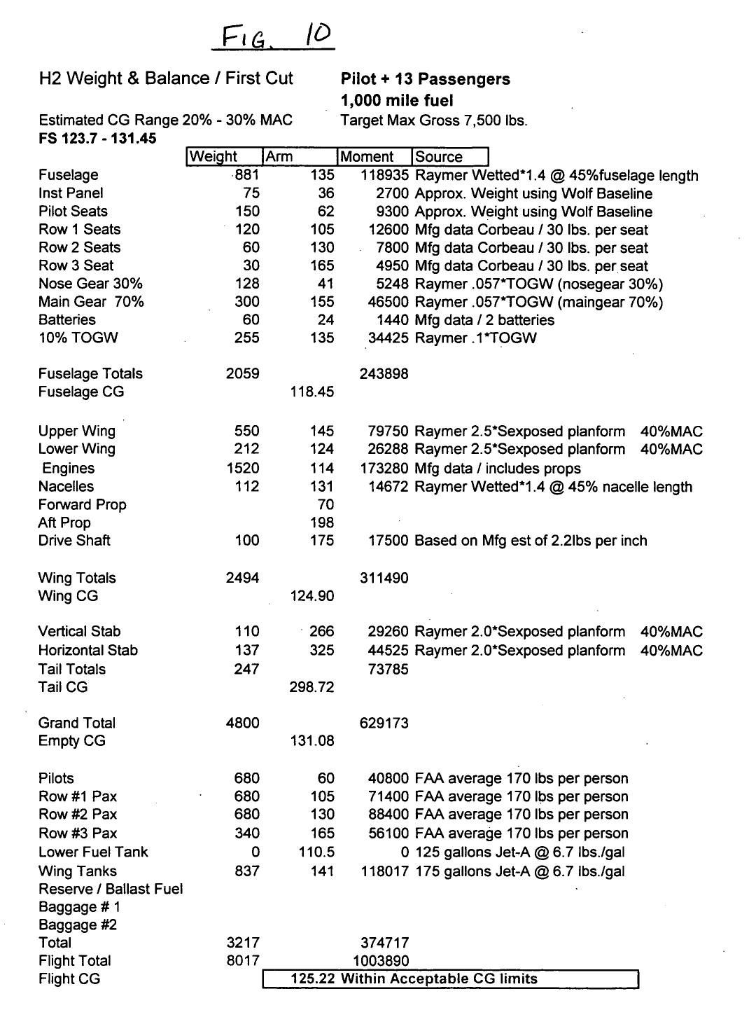

FIG. 5a shows an aircraft 10 according to one embodiment of the present invention. The aircraft 10 of FIG. 5a is suitable for carrying approximately 14 passengers. As shown in FIG. 5a the aircraft 10 has an overall length of approximately 378 inches and an overall height of approximately 123 inches. The dimensions of the vertical stabilizer 26, horizontal stabilizer 32, upper wing 16, and lower wing 20 are shown in FIGS. 6-9 that depict the respective portions of aircraft 10 shown in FIG. 5a. The propulsion device 24 takes the form of two 310 horsepower turbo diesel engines. Such an engine is sold under the brand name Centurion in a V8 form. The fuselages 12 and 14 as well as the wings 16 and 20 are formed from carbon graphite composite. The aircraft 10 has a gross weight of approximately 4800 lbs when it is empty. Fuel tanks may be provided within the wings and especially within the upper wing 16. Additionally, reserve tanks may be provided within the fuselages 12 and 14. When loaded with 14 total passengers, including the pilot, and enough fuel to fly for a range of 1,000 miles, the aircraft 10 will weigh approximately 8,000 lbs. The aircraft 10 will have a cruising speed of approximately 200 mph.

Calculations may be made to determine location of the center of gravity 58 of the aircraft 10 by assigning a weight to each component of the aircraft 10 and multiplying that weight times a moment arm equal to the effective distance of that component from the front of the aircraft 10. The total of moments of all the components relative to the front of the aircraft 10 may then be summed and divided by the total weight of all the components to determine the location of the center of gravity relative to the front of the aircraft 10. FIG. 10 shows such a calculation for the embodiment of FIG. 5a. The vertical location of the center of gravity can similarly be determined by calculating the moment of all of the components of the aircraft 10 relative to a lower edge of the aircraft 10. It should be appreciated that the location of the center of gravity 58 of the aircraft 10 may vary depending upon the amount and location of fuel remaining in the fuel tanks, and the distribution of passengers and cargo within the fuselages 12 and 14.

Preferably the center of gravity 58 will be located such that the angle γ falls in the range of 10-20 degrees. Furthermore, it is preferable that the center of gravity 58 be located below the upper wing 16 and above the lower wing 20. By utilizing the fuselages 12 and 14 as the floatation pontoons, the stability of the aircraft 10 in water is greatly enhanced.

Although various representative embodiments of this invention have been described above with a certain degree of particularity, those skilled in the art could make numerous alterations to the disclosed embodiments without departing from the spirit or scope of the inventive subject matter set forth in the specification and claims. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

I claim:

1. An aircraft comprising:
a first fuselage;
a second fuselage spaced apart from the first fuselage;
an upper airfoil mounted to and generally above the first and second fuselages;
a lower airfoil mounted to and generally between the first and second fuselages;
a propulsion device in operable connection to the upper airfoil; and
the fuselages both including lower portions that act as pontoons to permit the aircraft to land and take-off from water.

2. The aircraft of claim 1, wherein each fuselage is provided with retractable landing gear to permit ground take-offs and landings.

3. The aircraft of claim 1, wherein the fuselages and airfoils comprise carbon graphite composite material.

4. The aircraft of claim 1, wherein the bottom surface of the lower portions of the fuselages are provided with a step wherein a break occurs in the lateral orientation of the bottom surface such that the lateral orientation of the bottom surface is pitched aft of the step relative to the lateral orientation of the bottom surface forwardly from step.

5. The aircraft of claim 4, wherein a center of gravity for the aircraft is located generally above and forwardly from the step.

6. The aircraft of claim 5, wherein when the aircraft is at rest on a flat portion of ground, a first reference line that is normal to the portion of ground and intersects the step forms an angle of between 10 degrees and 20 degrees relative to a second reference line that passes through the center of gravity and the step.

7. The aircraft of claim 1, wherein a center of gravity of the aircraft is located below the upper wing and above the lower wing, when the aircraft is at rest on a level portion of ground.

8. The aircraft of claim 1 wherein one of the fuselages comprises a front nose portion that is pivotally attached to the one fuselage such that the nose portion may be pivoted upwardly to provide a large opening into the fuselage.

9. The aircraft of claim 1, wherein each of the fuselages comprises a vertical stabilizers at aft portions of the fuselages.

10. The aircraft of claim 9, wherein a horizontal stabilizer spans between top portions of the vertical stabilizers.

11. The aircraft of claim 10, wherein the horizontal stabilizer has a generally pentagonal shape with a base portion that is perpendicular to a direction travel for the aircraft.

12. The aircraft of claim 1, wherein the fuselages are shaped to maintain laminar airflow across the fuselages during flight.

13. The aircraft of claim 1, wherein the airfoils are shaped to maintain laminar airflow across the airfoils during flight.

14. The aircraft of claim 1, wherein the fuselages, the airfoils, and the propulsion device are configured to eliminate asymmetrical thrust.

15. The aircraft of claim 14, wherein the propulsion device comprises two engines in axial alignment with a center of gravity of the aircraft.
